(19) United States
(12) Patent Application Publication
(10) Pub. No.: US 2005/0242969 A1
(43) Pub. Date: Nov. 3, 2005

(54) Decorative light system for motor vehicles

(76) Inventors: Daniel Deutsch, Orlando, FL (US); Jason Barber, Orlando, FL (US); Russell Rothan, Orlando, FL (US)

Correspondence Address: ENRIQUE G. ESTEVEZ, 255 SOUTH ORANGE AVE, SUITE 1401, ORLANDO, FL, 32802-3791, US

(21) Appl. No.: 11/060,063

(22) Filed: Feb. 17, 2005

Related U.S. Application Data
(60) Provisional application No. 60/545,060, filed on Feb. 17, 2004.

(51) Int. Cl. G08B 5/22

(52) U.S. Cl. 340/815.45; 340/468; 362/459

(57) ABSTRACT

A light system for a motor vehicle includes a hand-held remote control unit is capable of generating a wireless or infrared signal containing one or more commands. A sensor is capable of recognizing the signal from the remote control and generates a sensor signal responsive thereto. A CPU is operable on direct current and contains a microcontroller and connected to said sensor to thereby generate a control signal responsive to said sensor signal. The CPU also has an input for receiving a signal containing sound information and is capable of coordinating the control signal with the sound information. A light unit has a substantially weather resistant housing made at least partially of light penetrable material and contains therein a plurality of LEDs operatively connected to said CPU, said plurality of LEDs being capable of generating light containing one or more wavelengths responsive to the control signal from the CPU.

### RELATED APPLICATION

This application claims priority from co-pending provisional application Ser. No. 60/545,060, which was filed on Feb. 17, 2004, and which is incorporated herein by reference in its entirety.

### FIELD OF THE INVENTION

The present invention relates to the field of vehicle lights and, more particularly, to decorative lights for motor vehicles.

### BACKGROUND OF THE INVENTION

Lights mounted to a motor vehicle's undercarriage have become popular items used to distinctively decorate cars, trucks, and the like. Typically, these lights have been fluorescent, neon-type lights which have a limited range in their intensity and color-producing ability. Additionally, such lights and lighting systems have provided the user only limited ability to customize the lighting effects.

### SUMMARY OF THE INVENTION

With the foregoing in mind, the present light system includes a programmable microcontroller in a central processing unit (CPU) and a wireless transmission capability. One or more light sticks comprising an array of light-emitting diodes (LEDs) are operably connected to the controller, the system being connected to a source of power, typically, the vehicle's battery or electrical system. A hand-held remote control communicates by wireless signals, preferably infrared signals which are received by a sensor connected to the controller, and allows the user to turn the system on or off, to program the system to produce lighting effects which are user-defined, to choose lighting effects programs from a plurality of programs stored in the CPU, to increase or decrease the intensity of the light output by the system, and to coordinate the lighting effects with the vehicle's music system so as to choreograph the lighting effects to the beat of selected music.

### BRIEF DESCRIPTION OF THE DRAWINGS

Some of the features, advantages, and benefits of the present invention having been stated, others will become apparent as the description proceeds when taken in conjunction with the accompanying drawings, presented solely for exemplary purposes and not with intent to limit the invention thereto, and in which:

FIG. 1 is an overall schematic diagram of the light system according to an embodiment of the present invention;

FIG. 2 shows a schematic of the light system of FIG. 1 as it might be installed in a motor vehicle;

FIG. 3 shows a side elevation view of a light stick according to the present invention, including closeup detail of its cable connectors;

FIG. 4 is a top plan view of two light sticks as they may be connected in the present light system;

FIG. 5 illustrates the use of connectors for securing a light stick of the present invention to the motor vehicle, preferably its undercarriage;

FIG. 6 depicts how the present light stick is best oriented when mounted on a motor vehicle's undercarriage;

FIG. 7 is a top plan detailed view of an embodiment of the hand-held remote control unit of the invention as also shown in FIG. 1;

FIG. 8 shows a schematic diagram of one possible audio connection in the present invention; and

FIG. 9 shows a schematic diagram of an alternate audio connection in the present invention.

### DETAILED DESCRIPTION OF THE PREFERRED EMBODIMENT

The present invention will now be described more fully hereinafter with reference to the accompanying drawings, in which preferred embodiments of the invention are shown. Unless otherwise defined, technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. Any publications, patent applications, patents, and other references mentioned herein are incorporated by reference in their entirety. In case of conflict, however, the present specification, including any definitions, will control. In addition, the materials, methods and examples given are illustrative in nature only and not intended to be limiting. Accordingly, this invention may be embodied in many different forms and should not be construed as limited to the illustrated embodiments set forth herein. Rather, these illustrated embodiments are provided solely for exemplary purposes so that this disclosure will be thorough and complete, and will fully convey the scope of the invention to those skilled in the art. Other features and advantages of the invention will be apparent from the following detailed description, and from the claims.

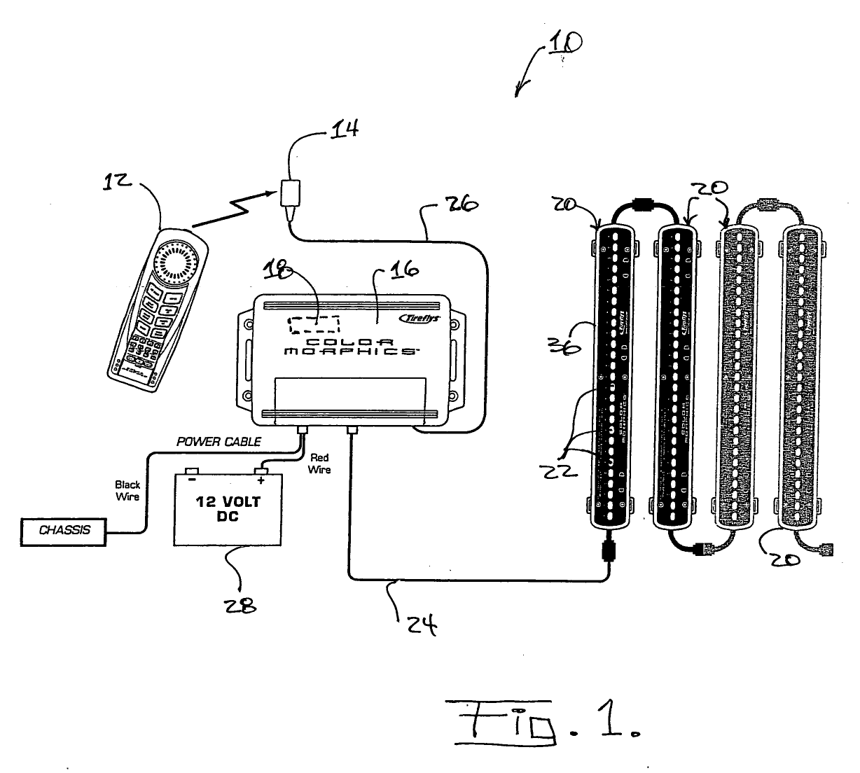

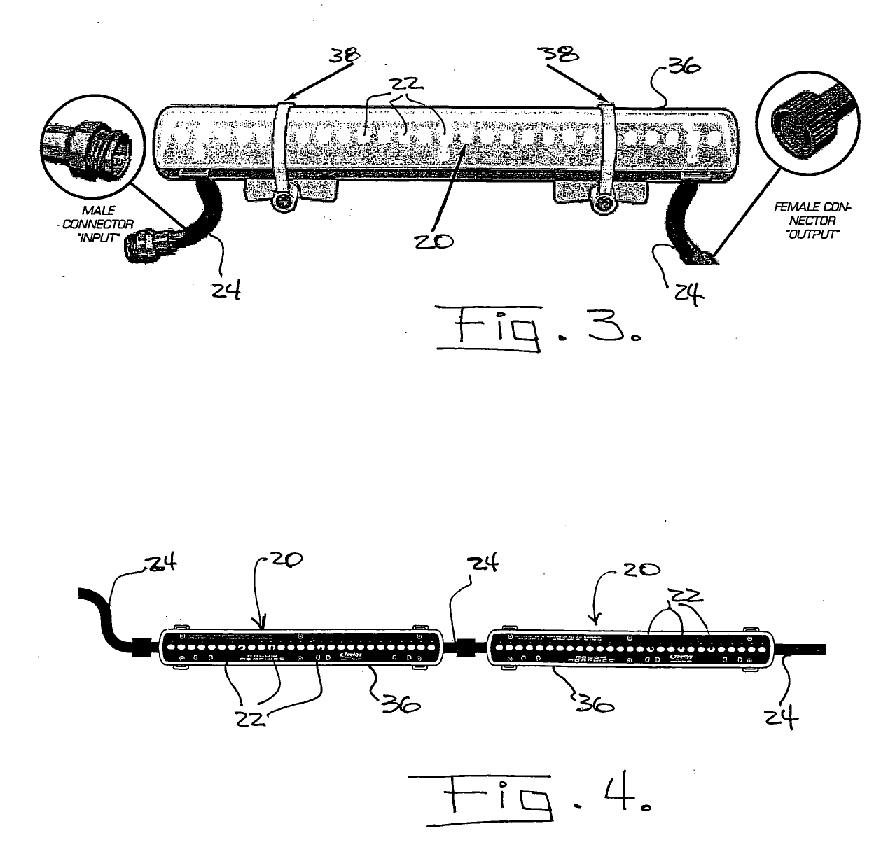

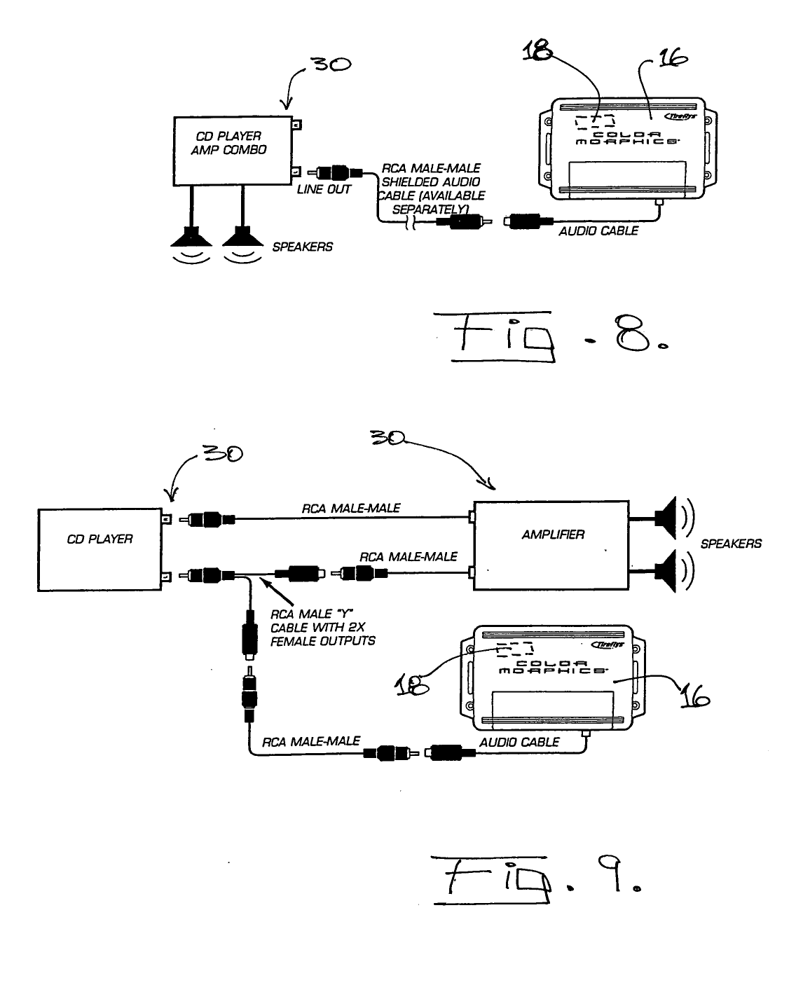

A preferred embodiment of the present invention is shown in FIGS. 1-9. The light system 10 includes a hand-held remote control unit 12, a sensor 14 which receives a signal from the remote control unit, a central processing unit (CPU) 16 having a microcontroller 18, and one or more lights 20, also termed herein “light sticks”, which comprise an array of light-emitting diodes 22 (LEDs). The light sticks 20 are connected to the CPU 16 by a data cable 24 capable of carrying control signals from the microcontroller 18. An example of a microcontroller 18 suitable for use in the invention is Motorola's PIC18F258, a programmable integrated circuit. The skilled will recognize that there are many other similar integrated circuits which may be employed in the invention.

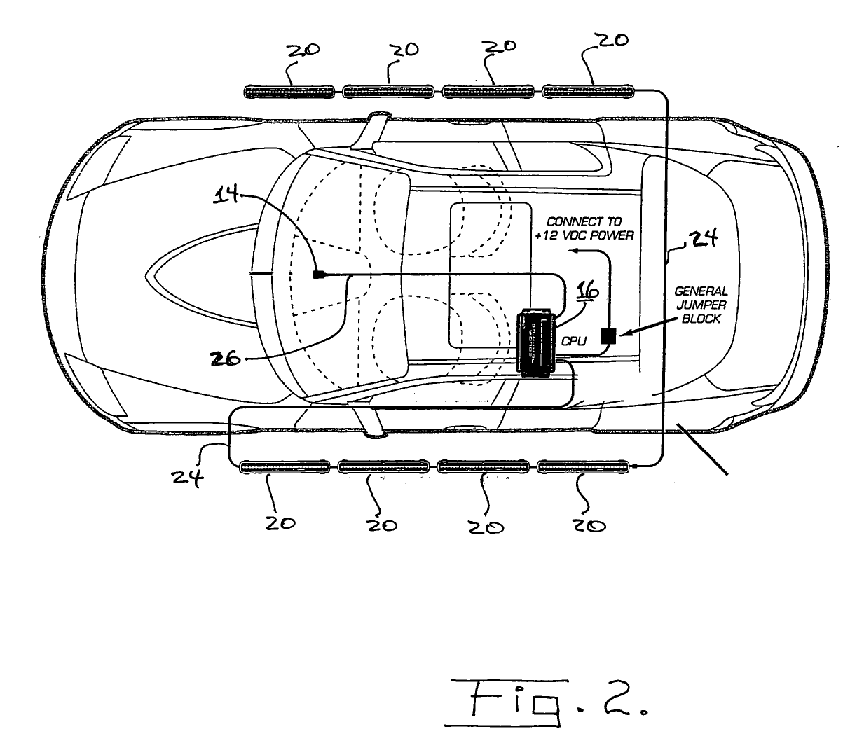

A sensor 14 or wireless transceiver capable of recognizing an infrared or wireless signal from the remote control unit 12 is operably connected with the CPU, typically by a hardwired connection 26. At least one light stick and, preferably, a plurality of light sticks, is operably connected with the CPU. As the skilled will realize, the system is connected to a source of power 28, usually the vehicle's battery or other point along the vehicle's electrical system, as illustrated in FIGS. 1 and 2. The remote control unit 12 is sized suitably for being easily hand-held, and preferably includes its own source of power which is usually one or more replaceable batteries but could also be connected to and/or rechargeable through the vehicle's electrical system.

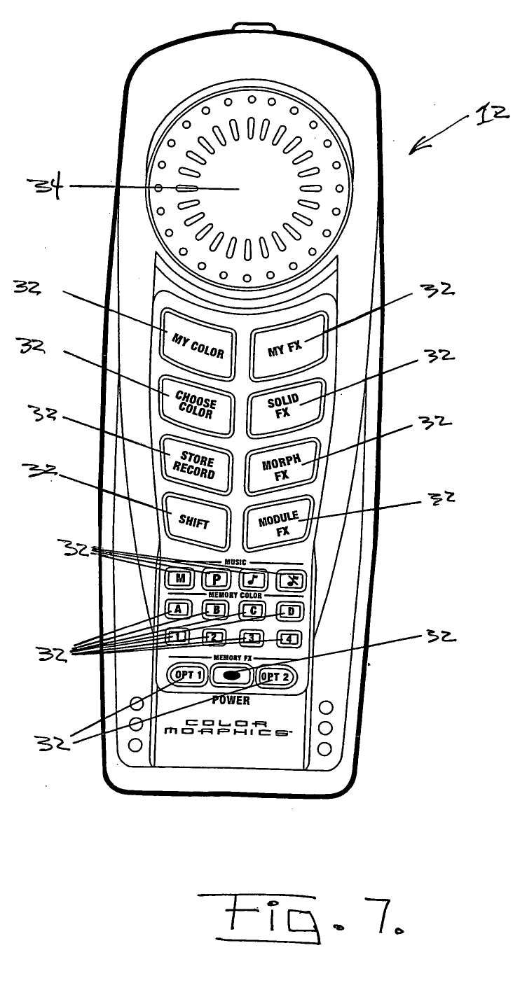

As shown in FIG. 7, the remote control unit 12 preferably provides the user with the flexibility of various functions, including the ability to program the micro controller 18 to produce user-defined lighting effects. A preferred method of wireless communication between the remote control unit 12 and the CPU 16 is by means of infrared light, which is generated by the remote control unit responsive to a user's input and is detected by a sensor 14 having the capability of recognizing the infrared signal, the sensor being connected to the CPU, as shown in FIGS. 1-2. The remote control unit 12, wirelessly communicating with the CPU 16 through the sensor 14, allows the user to select and activate a predetermined lighting effects program and to coordinate the lighting effects program with the vehicle's sound system 30 so as to choreograph the light show to music, and particularly to the beat of the music. Through the remote control unit 12, as seen in FIG. 7, the user may designate a predetermined color or color combination as “MY COLOR”, and may designate a particular lighting effect as “MY FX.” The user also may choose a particular color for a lighting effect and whether the effect is to remain steady, or whether it is to flash or blink or to “morph” or change with time. As shown in FIG. 7, the remote control unit 12 includes keys for coordinating the lighting effects with music, shown along the upper row of keys. Keys 32 in the lower key pad may also be used to call and activate specific lighting effects programs stored in the CPU 16 and to program that unit. As seen in FIGS. 1 and 7, a rotatable control 34, preferably a generally hemispherical control wheel, is positioned at an upper end of the remote control unit. The rotatable control wheel 34 may be easily manipulated with the thumb of the user and provides an additional means of control for the lights, that is, through this rotatable control the user may slow the rate of flashing of the lights or increase the flashing speed within a given range.

FIGS. 1-2 also show the protective housing in which the CPU 16 is positioned. Preferably, the CPU's 16 housing is substantially dust and water proof, so as to safely contain the electronic components of the central processing unit. The CPU 16 housing is best made of a high impact resistant plastic material which is also heat resistant. The CPU 16 in the present invention preferably includes one or more fuses to electrically protect the device. The skilled will recognize that the CPU 16 includes known components for performing the various described functions of the lighting effects system. As noted above, a typical programmable integrated circuit chip for use in the invention is the Motorola PIC18F258, although others may also be employed. The CPU 16 may be mounted in the vehicle in any desired location, or illustrated schematically in FIG. 2, preferably having relatively easy access to the user for replacement of fuses when necessary, as well as easy access to a source of power 28. As noted above, the CPU 16 includes at least a user-programmable microcontroller 18 and may also include a wireless transceiver for communicating with the remote control unit 12. Preferably, however, the wireless communication is effected through a sensor 14 connected to the CPU 16, the sensor being capable of recognizing infrared signals or wireless signals, including radio frequency signals, according to the particular embodiment of the invention. When employing radio signals, the specific wireless frequency for the unit may be selected through the use of a combination of user-selectable switches in the CPU, so as to minimize interference from other signal sources.

Various views of light sticks 20 for use in the present invention are shown in FIGS. 1-5. Overall views of the light stick 20 are seen in FIGS. 1, 3 and 4, wherein the light stick is shown with its protective transparent plastic domed housing 36 in place. The array of LEDs 22 in the light stick 20 is illustrated in these figures. The skilled will recognize that, as noted above, these LEDs 22 may be energized either individually or jointly in various combinations. When energized jointly in combinations, the light emitted from the combined lit LEDs 22 will mix to produce light of a predetermined color, generally different than the light from each LED alone. Additionally, the LEDs 22 may be energized intermittently, simultaneously, sequentially or in combination thereof to generate an almost limitless range of light colors and lighting effects. A preferred embodiment of the present invention includes a sequence of LEDs 22 in which groups of red, green and blue LEDs repeat throughout the light stick 20. When energized in combination, these three types of LED produce light which when mixed results in white light.

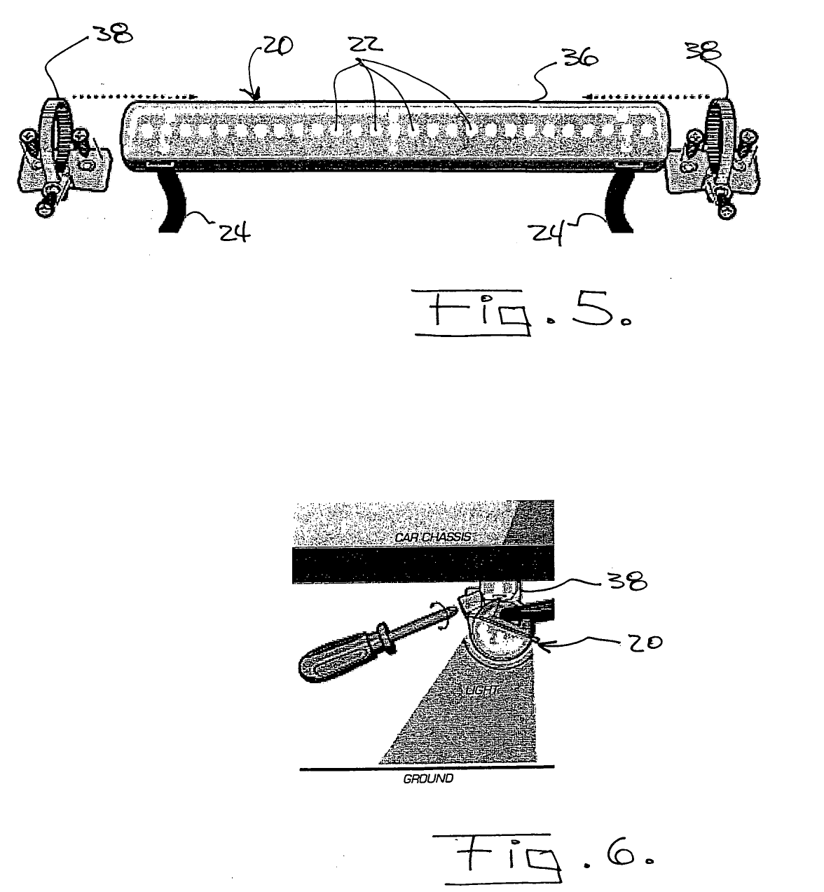

FIGS. 3 and 5 show a light stick 20 having thereon connectors 38 for securing the light stick to a vehicle, preferably along the undercarriage of a vehicle. The light sticks 20 may be placed anywhere on the vehicle as desired by the owner provided it is not prohibited by law. For example, many localities prohibit the use of blue lights on a motor vehicle, as such use is normally reserved for law enforcement vehicles. The connectors 38 are preferably made of a clear plastic material so as to minimize their interference with the emitted light. Further, the connectors 38 should be a high temperature and high impact resistant plastic, so as to survive and provide long service in the adverse environment of a vehicle's undercarriage. It should be understood, however, that while a specific type of connector 38 is shown, other means of connecting the light stick to the vehicle may also be employed and are intended to be within the scope of the present invention.

Accordingly, in the drawings and specification there have been disclosed typical preferred embodiments of the invention and, although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as recited in the appended claims.

1. A light system for a motor vehicle, comprising:
a hand-held remote control unit capable of generating an infrared signal containing one or more commands;
a sensor capable of recognizing the infrared signal and generating a sensor signal responsive thereto;
a central processing unit operable on direct current, containing a microcontroller and connected to said sensor to thereby generate a control signal responsive to said sensor signal, said central processing unit having an input for receiving a signal containing sound information and being capable of coordinating the control signal with the sound information; and
a light unit having a substantially weather resistant housing made at least partially of light penetrable material and containing therein a plurality of light-emitting diodes operatively connected to said central processing unit, said plurality of light-emitting diodes being capable of generating light containing one or more wavelengths responsive to the control signal from said central processing unit.

2. The light system of claim 1, further comprising a substantially water proof data cable connecting said light unit with said central processing unit.

3. The light system of claim 1, further comprising one or more connectors adapted for connecting said light unit to the motor vehicle.

4. The light system of claim 1, wherein the one or more commands in the infrared signal are selected from commands specifying intensity, duration, and color of the light generated, and combinations thereof.

5. The light system of claim 1, wherein said remote control unit contains a power source.

6. The light system of claim 1, wherein said remote control unit includes illumination effective for enhancing its visibility in low ambient light conditions.

7. The light system of claim 1, wherein the one or more wavelengths of light comprise red, green, blue and combinations thereof.

8. The light system of claim 1, wherein the one or more wavelengths of light comprise a color selected from white, a primary color, ultraviolet, near-ultraviolet and combinations thereof.

9. A light system for a motor vehicle, comprising:
a hand-held remote control unit having an input keyboard containing a plurality of pressure-activated keys and a rotatable control whereby commands are generated and transmitted from said remote control unit in a wireless signal;
a sensor capable of recognizing the wireless signal and generating a sensor signal responsive thereto;
a central processing unit operable on direct current, containing a microcontroller and connected to said sensor to thereby generate a control signal responsive to said sensor signal, said central processing unit having an input for receiving a signal containing sound information and being capable of coordinating the control signal with the sound information; and
a plurality of light-emitting diodes operatively connected to said central processing unit, said plurality of light-emitting diodes being capable of generating light containing one or more colors responsive to the control signal from said central processing unit.

10. The light system of claim 9, further comprising a substantially water proof data cable connecting said light unit with said central processing unit.

11. The light system of claim 9, further comprising one or more connectors adapted for connecting said light unit to the motor vehicle.

12. The light system of claim 9, wherein the commands in the wireless signal are selected from commands specifying intensity, duration, and color of the light generated, and combinations thereof.

13. The light system of claim 9, wherein said remote control unit contains a power source.

14. The light system of claim 9, wherein said remote control unit includes illumination effective for enhancing its visibility to a user in low ambient light conditions.

15. The light system of claim 9, wherein the one or more colors of light comprise red, green, blue and combinations thereof.

16. The light system of claim 9, wherein the one or more wavelengths of light comprise a color selected from white, a primary color, ultraviolet, near-ultraviolet and combinations thereof.

17. A light system for a motor vehicle, comprising:
a hand-held remote control unit having an input keyboard and a rotatable control whereby commands are generated and transmitted from said remote control unit in a wireless signal;
a sensor capable of recognizing the wireless signal and generating a sensor signal responsive thereto;
a central processing unit having a microcontroller and connected to said sensor to thereby generate a control signal responsive to said sensor signal, said central processing unit having an input connectable to a sound system positioned in the motor vehicle to thereby receive a signal containing sound information, said central processing unit being capable of coordinating the control signal with the sound information; and
a light stick having an approximately cylindrical and at least partially translucent weather resistant housing containing a plurality of light-emitting diodes operatively connected to said central processing unit, said plurality of light-emitting diodes being capable of generating light having variable intensity and duration, and containing one or more colors responsive to the control signal from said central processing unit.

18. The light system of claim 17, further comprising a substantially water proof data cable connecting said light unit with said central processing unit.

19. The light system of claim 17, further comprising one or more connectors adapted for connecting said light unit to the motor vehicle.

20. The light system of claim 17, wherein the one or more commands in the infrared signal are selected from commands specifying intensity, duration, and color of the light generated, and combinations thereof.

21. The light system of claim 17, wherein said remote control unit contains a power source.

22. The light system of claim 17, wherein said remote control unit contains illumination effective for enhancing its visibility in low ambient light conditions.

23. The light system of claim 17, wherein the one or more colors of light comprise red, green, blue and combinations thereof.

24. The light system of claim 17, wherein the one or more wavelengths of light comprise a color selected from white, a primary color, ultraviolet, near-ultraviolet and combinations thereof.
